(19) United States
(12) Patent Application Publication
(10) Pub. No.: US 2025/0014554 A1
(43) Pub. Date: Jan. 9, 2025

(54) METHOD FOR OUTPUTTING DATA, DATA OUTPUT DEVICE AND ELECTRONIC MUSICAL INSTRUMENT

(71) Applicant: YAMAHA CORPORATION, Hamamatsu-shi (JP)

(72) Inventors: Katsumi ISHIKAWA, Hamamatsu-shi (JP); Takuya FUJISHIMA, Hamamatsu-shi (JP); Takuma TAKEMOTO, Hamamatsu-shi (JP); Yoshinari NAKAMURA, Hamamatsu-shi (JP); Rei NISHIYAMA, Hamamatsu-shi (JP); Yoshikazu NOFUJI, Tokyo (JP)

(21) Appl. No.: 18/887,154

(22) Filed: Sep. 17, 2024

Related U.S. Application Data
(63) Continuation of application No. PCT/JP2022/048175, filed on Dec. 27, 2022.

(30) Foreign Application Priority Data
Mar. 25, 2022 (JP) 2022-049805

(51) Int. Cl. G10H 1/36; G10H 1/00

(52) U.S. Cl. CPC G10H 1/361; G10H 1/0008; G10H 2210/005; G10H 2220/455

(57) ABSTRACT

A method for outputting data according to an embodiment includes acquiring performance data generated by a performance operation, specifying a musical score performance position in a predetermined musical score based on the performance data, reproducing first data based on the musical score performance position, assigning first position information, corresponding to a first virtual position set corresponding to the first data, to the first data, and outputting playback data including the first data to which the first position information is assigned.

### CROSS REFERENCE TO RELATED APPLICATIONS

This application is a Continuation of International Patent Application No. PCT/JP2022/048175, filed on Dec. 27, 2022, which claims the benefit of priority to Japanese Patent Application No. 2022-049805, filed on Mar. 25, 2022, the entire contents of which are incorporated herein by reference.

### FIELD

The present disclosure relates to a technique for outputting data.

### BACKGROUND

A technique has been proposed for specifying a performance position on a musical score in a predetermined musical piece by analyzing sound data about the musical piece acquired by a performance of a user. A technique for realizing automatic performance following the performance by the user by applying this technique to an automatic performance has also been proposed (for example, Japanese Laid-Open Patent Publication No. 2017-207615).

It is possible to acquire a sense of performing a musical piece by a plurality of people even if the performance is performed by one person by making the automatic performance follow the performance of the user. There is a demand for a user to have increased realism.

### SUMMARY

A method for outputting data according to an embodiment is provided, the method includes acquiring performance data generated by a performance operation, specifying a musical score performance position in a predetermined musical score based on the performance data, reproducing first data based on the musical score performance position, assigning first position information, corresponding to a first virtual position set corresponding to the first data, to the first data, and outputting playback data including the first data to which the first position information is assigned.

### BRIEF DESCRIPTION OF DRAWINGS

FIG. 1 is a diagram for explaining a system configuration according to a first embodiment.

FIG. 2 is a diagram explaining a configuration of an electronic musical instrument according to the first embodiment.

FIG. 3 is a diagram explaining a configuration of a data output device according to the first embodiment.

FIG. 4 is a diagram explaining position control data according to the first embodiment.

FIG. 5 is a diagram explaining position information and direction information in the first embodiment.

FIG. 6 is a diagram explaining a configuration for realizing a performance following function in the first embodiment.

FIG. 7 is a diagram explaining a method for outputting data according to the first embodiment.

FIG. 8 is a diagram explaining a configuration for realizing a performance following function in a second embodiment.

### DESCRIPTION OF EMBODIMENTS

Hereinafter, an embodiment of the present disclosure will be described in detail with reference to the drawings. The following embodiments are examples, and the present disclosure is not to be construed as being limited to these embodiments. In the drawings referred to in the embodiments described below, the same or similar parts are denoted by the same reference signs or similar reference signs (only denoted by A, B, or the like after the numerals), and repeated description thereof may be omitted. In order to clarify the description of the drawings, a part of the configuration may be omitted from the drawings or may be schematically described.

An object of the present disclosure is to enhance a sense of realism given to a user in an automatic process following a performance of a user.

### First Embodiment

### [Overview]

A data output device according to an embodiment of the present disclosure realizes an automatic performance corresponding to a predetermined musical piece following a performance of a user on an electronic musical instrument. A subject of the automatic performance is set to various musical instruments. In the case where the electronic musical instrument played by the user is an electronic piano, musical instruments other than the piano part, for example, vocals, bass, drums, guitar, and horn section or the like are assumed as the musical instruments to be automatically played. In this example, the data output device provides the user with a playback sound acquired by the automatic performance and an image imitating the player (hereinafter, sometimes referred to as a player image) of the musical instrument. According to this data output device, it is possible to give a user a sense of performing a performance together with another player. Hereinafter, a data output device and a system including the data output device will be described.

### [System Configuration]

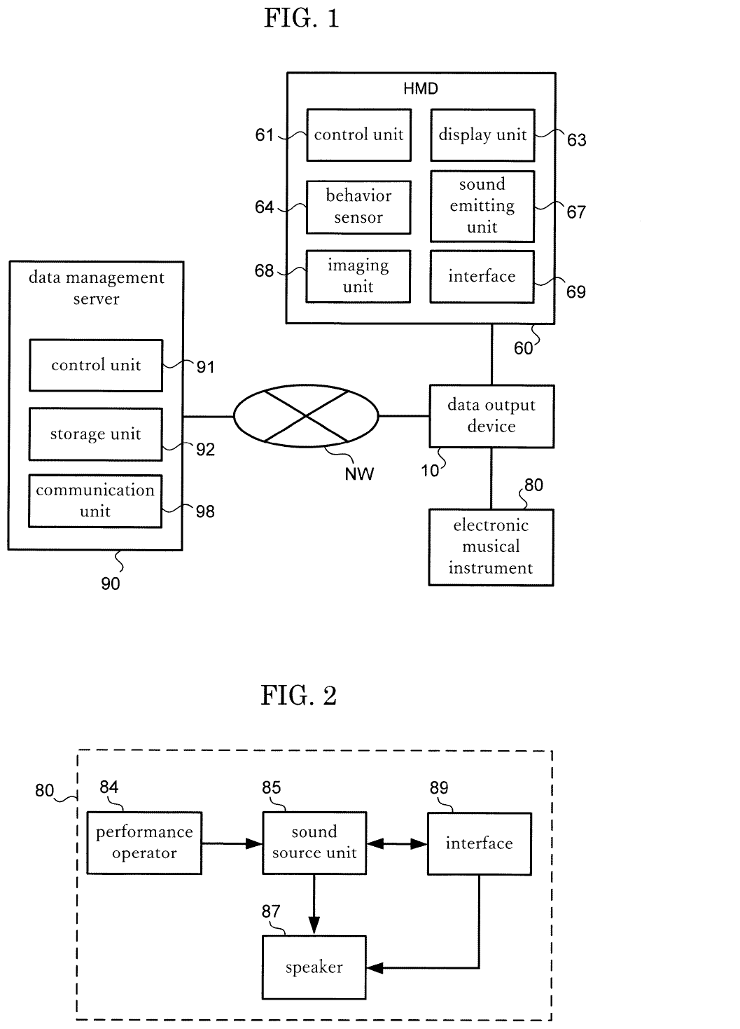

FIG. 1 is a diagram for explaining a system configuration according to a first embodiment. The system shown in FIG. 1 includes a data output device 10 and a data management server 90 connected via a network NW such as the Internet. In this embodiment, a head-mounted display 60 (hereinafter, sometimes referred to as an HMD 60) and an electronic musical instrument 80 are connected to the data output device 10. In this example, the data output device 10 is a computer such as a smartphone, a tablet personal computer, a laptop personal computer, or a desktop personal computer. In this example, the electronic musical instrument 80 is an electronic keyboard device such as an electronic piano.

As described above, the data output device 10 has a function for executing an automatic performance following a performance and outputting data based on the automatic performance (hereinafter referred to as a performance following function) in the case where the user plays a predetermined musical piece using the electronic musical instrument 80 as described above. Details of the data output device 10 will be described later.

The data management server 90 includes a control unit 91, a storage unit 92, and a communication unit 98. The control unit 91 includes processors such as a CPU and a storage device such as a RAM. The control unit 91 executes a program stored in the storage unit 92 using the CPU, thereby performing a process according to an instruction described in the program. The storage unit 92 includes a storage device such as a nonvolatile memory or a hard disk drive. The communication unit 98 is connected to a network NW and includes a communication module for communicating with other devices. The data management server 90 provides music data to the data output device 10. The music data is data related to an automatic performance, and will be described in detail later. In the case where the music data is provided to the data output device 10 in other ways, the data management server 90 does not need to be present.

In this embodiment, the HMD 60 includes a control unit 61, a display unit 63, a behavior sensor 64, a sound emitting unit 67, an imaging unit 68, and an interface 69. The control unit 61 includes a CPU, a RAM and a ROM, and controls respective components in the HMD 60. The interface 69 includes connection terminals for connecting to the data output device 10. The behavior sensor 64 includes, for example, an accelerometer, a gyroscope, and the like, and is a sensor that measures the behavior of the HMD 60, for example, a change in a direction of the HMD 60, and the like. In this example, measurement results obtained by the behavior sensor 64 are provided to the data output device 10. This allows the data output device 10 to recognize movement of the HMD 60. In other words, the data output device 10 can recognize the movement of the user wearing the HMD 60 (head movement or the like). The user can enter instructions into the data output device 10 via the HMD 60 by moving his/her head. If an operation unit is arranged on the HMD 60, the user can also enter instructions to the data output device 10 via the operation unit.

The imaging unit 68 includes an image sensor, captures an image of a front side of the HMD 60, that is, a front side of the user wearing the HMD 60, and generates image data. The display unit 63 includes a display for displaying an image corresponding to video data. The video data is included in, for example, playback data provided from the data output device 10. The display has a spectacle-like form. The display may be semi-transmissive so that the user wearing the display can visually recognize the outside. In the case where the display is non-transmissive, an area captured by the imaging unit 68 may be superimposed on the video data and displayed on the display. This allows the user to view the exterior of the HMD 60 via the display. The sound emitting unit 67 is, for example, headphones and includes a vibrator. The vibrator converts a sound signal corresponding to sound data into air vibration, and provides sounds to the user wearing the HMD 60. The sound data is included in, for example, the playback data provided from the data output device 10.

### [Electronic Musical Instrument]

FIG. 2 is a diagram explaining a configuration of an electronic musical instrument according to the first embodiment. In this example, the electronic musical instrument 80 is an electronic keyboard device such as an electronic piano, and includes a performance operator 84, a sound source unit 85, a speaker 87, and an interface 89. The performance operator 84 includes a plurality of keys, and outputs a signal corresponding to an operation on each key to the sound source unit 85.

The sound source unit 85 includes a DSP (Digital Signal Processor) and generates sound data including a sound wave form signal corresponding to an operation signal. The operation signal corresponds to a signal output from the performance operator 84. The sound source unit 85 converts the operation signal into sequence data (hereinafter, referred to as operation data) in a predetermined format for controlling the generation of sound (hereinafter, referred to as sound generation), and outputs the sequence data to the interface 89. The predetermined format is a MIDI format in this instance. Thus, the electronic musical instrument 80 can transmit the operation data corresponding to the performance operation to the performance operator 84 to the data output device 10. The operation data is information that defines the content of sound generation, and is sequentially output as sound generation control information such as a note-on, a note-off, and a note number. The sound source unit 85 may provide sound data to the interface 89 and the speaker 87, or may provide sound data to the speaker 87 instead of providing the sound data to the interface 89.

The speaker 87 may convert a sound wave form signal corresponding to the sound data provided from the sound source unit 85 into air vibration and provide the air vibration to the user. The speaker 87 may provide sound data from the data output device 10 via the interface 89. The interface 89 includes a module for transmitting and receiving data wirelessly or by wire to and from an external device. In this example, the interface 89 is connected to the data output device 10 by wire, and transmits the operation data and the sound data generated by the sound source unit 85 to the data output device 10. These data may be received from the data output device 10.

### [Data Output Device]

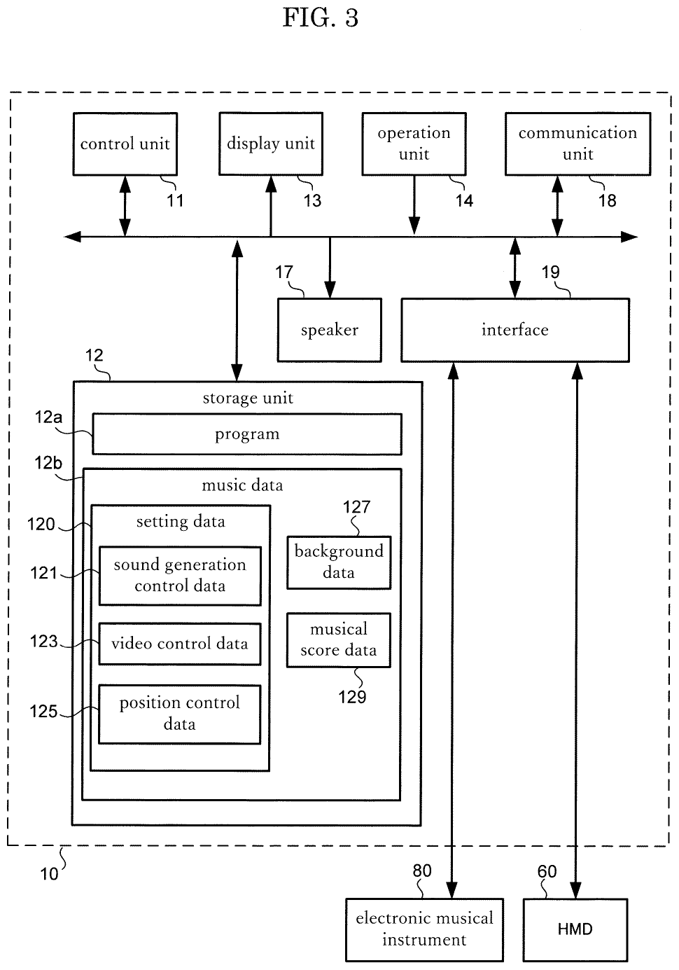

FIG. 3 is a diagram explaining a configuration of a data output device according to the first embodiment. The data output device 10 includes a control unit 11, a storage unit 12, a display unit 13, an operation unit 14, a speaker 17, a communication unit 18, and an interface 19. The control unit 11 is an exemplary computer including a processor such as a CPU and a storage device such as a RAM. The control unit 11 executes a program 12a stored in the storage unit 12 using a CPU (processor), and causes the data output device 10 to realize functions for executing various processes. The functions realized in the data output device 10 include a performance following function described later.

The storage unit 12 is a storage device such as a nonvolatile memory or a hard disk drive. The storage unit 12 stores various data such as a program 12a executed by the control unit 11 and music data 12b required when the program 12a is executed. The storage unit 12 may be programmed in this manner. In this case, the data output device 10 may include a device that reads the recording medium. The storage unit 12 may be an example of the recording medium.

Similarly, the music data 12b may be downloaded from the data management server 90 or another server through the network NW and stored in the storage unit 12, or may be provided to a non-transitory computer while being recorded on a readable recording medium. The music data 12b is data stored in the storage unit 12 for each musical piece, and includes setting data 120, background data 127, and musical score data 129. The music data 12b will be described later.

The display unit 13 is a display having a display region for displaying various screens under control of the control unit 11. The operation unit 14 is an operation device that outputs a signal corresponding to an operation by the user to the control unit 11. The speaker 17 generates sounds by amplifying and outputting sound data supplied from the control unit 11. The communication unit 18 is a communication module that is connected to the network NW and communicates with other devices such as the data management server 90 connected to the network NW under the control of the control unit 11. The interface 19 includes a module for communicating with an external device by wireless communication such as infrared communication or short-range wireless communication or wired communication. The external device, in this instance, includes the electronic musical instrument 80 and the HMD 60. The interface 19 is used to communicate without going through the network NW.

### [Music Data]

Next, the music data 12b will be described. The music data 12b is data stored in the storage unit 12 for each musical piece, and includes the setting data 120, the background data 127, and the musical score data 129. In this instance, the music data 12b includes data for reproducing predetermined live performances following the performance of the user. The data for reproducing the live performance includes information about a form of a venue where the live performance is performed, a plurality of musical instruments (performance parts), a player of each performance part, a position of the player, and the like. Any one of the plurality of performance parts is identified as the performance part of the user. In this example, four performance parts (a vocal part, a piano part, a bass part, and a drum part) are defined. The performance part of the user is identified as the piano part among the four performance parts.

The musical score data 129 is data corresponding to a musical score of the performance part of the user. In this example, the musical score data 129 is data indicating a musical score of a piano part in a musical piece, and is data described in a predetermined format such as the MIDI format. That is, the score data 129 includes time information and sound generation control information associated with the time information. The sound generation control information is information that defines the content of sound generation at each time, and is indicated by, for example, information including timing information such as a note-on, a note-off, and a note number, and pitch information. The sound generation control information may further include text information, and may include singing sounds in a vocal part in sound generation. The time information is, for example, information indicating a playback timing with respect to a start of a song, and is indicated by information such as a delta time and a tempo. The time information can also be referred to as information for identifying a location on data. The musical score data 129 can also be referred to as data that defines musical sound control information in time series.

The background data 127 is data corresponding to the form of the venue where the live performance was performed, and includes data indicating a structure of a stage, structures of audience seats, a structure of a room, and the like. For example, the background data 127 includes coordinate data identifying a location of each structure and image data for recreating a space in the venue. The coordinate data is defined as coordinates in a predetermined virtual space. The background data 127 may include data for forming a background image imitating the venue in the virtual space.

The setting data 120 corresponds to each performance part in the music. Therefore, the music data 12b may include a plurality of pieces of setting data 120. In this case, the music data 12b includes setting data 120 corresponding to three parts that differ from the piano parts related to the music score data. Specifically, the three parts are a vocal part, a bass part, and a drum part. In other words, the setting data 120 exists corresponding to the player of each part. Setting data other than the player may exist, and for example, the setting data 120 corresponding to the audience may be included in the music data 12b. Even the audience can be treated as a part equivalent to one performance part because of movements and cheers that occur during the live performance.

The setting data 120 includes sound generation control data 121, video control data 123, and position control data 125. The sound generation control data 121 is data for reproducing sound data corresponding to a performance part, and is, for example, data described in a predetermined format such as the MIDI format. That is, the sound generation control data 121 includes time information and sound generation control information, similar to the musical score data 129. In this example, the sound generation control data 121 and the musical score data 129 are similar data except that the performance parts are different. The sound generation control data 121 can also be referred to as data that defines musical sound control information in time series.

The video control data 123 is data for reproducing video data, and includes time information and image control information associated with the time information. The image control information defines a player image at each time. As described above, the player image is an image imitating the player corresponding to the performance part. In this example, the reproduced video data includes a player image corresponding to a player who performs a performance related to a performance part. The video control data 123 can also be referred to as data that defines image control information in time series.

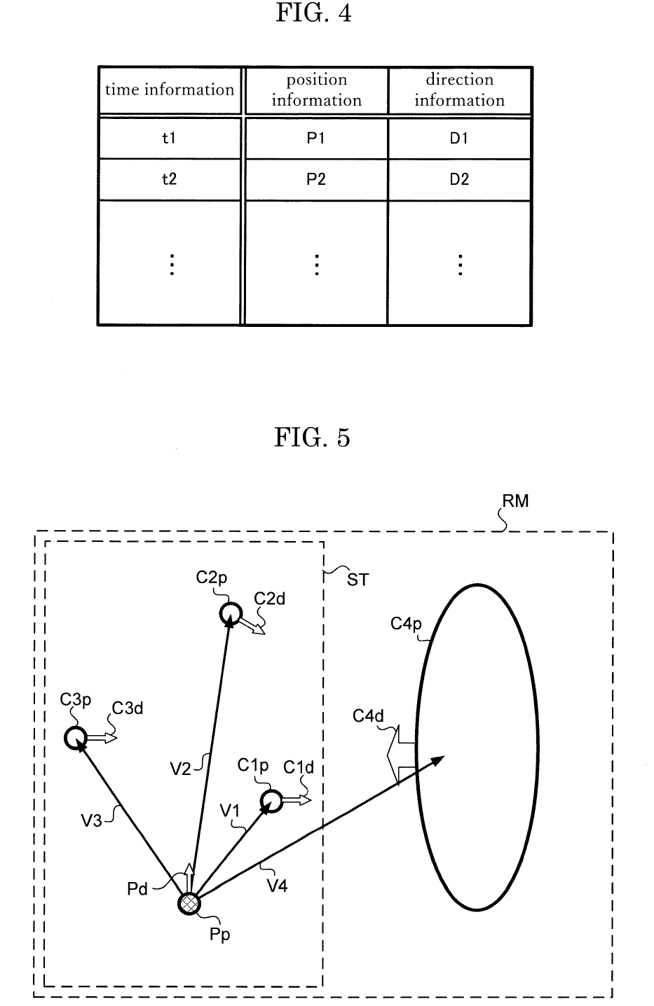

FIG. 4 is a diagram explaining position control data according to the first embodiment. The position control data 125 includes information indicating a position of a player corresponding to a performance part (hereinafter, referred to as position information) and information indicating a direction of the player (the front direction of the player) (hereinafter, referred to as direction information). In the position control data 125, the position information and the direction information are associated with time information. The position information is defined as coordinates in the virtual space used in the background data 127. The direction information is defined by an angle with respect to a predetermined direction in the virtual space. As shown in FIG. 4, as the time information advances to t1, t2, . . . , the position information changes to P1, P2, . . . , and the direction information changes to D1, D2, . . . . The position control data 125 can also be referred to as data that defines position information and direction information in time series.

FIG. 5 is a diagram explaining position information and direction information in the first embodiment. As described above, in this example, there are four pieces of setting data 120 corresponding to the three performance parts and audience. Therefore, the position control data 125 also exists corresponding to the three performance parts and the audience. FIG. 5 is an example of a predetermined virtual space viewed from above. In FIG. 5, a wall RM and a stage ST of the venue are defined by the background data 127. A player corresponding to each of the setting data is set with a virtual position corresponding to the position information defined in the position control data and a virtual direction corresponding to the direction information.

The virtual position and the virtual direction of the player of the vocal part are set in position information C1p and direction information C1d. A virtual position and a virtual direction of a player of the bass part are set in position information C2p and direction information C2d. A virtual position and a virtual direction of a player of the drum part are set in position information C3p and direction information C3d. A virtual position and a virtual direction of the audience are set to position information C4p and direction information C4d. Here, the players are located on the stage ST. The audience is located in an area other than the stage ST (audience seat). The example shown in FIG. 5 is a situation at a specific time. Therefore, the virtual positions and the virtual directions of the players and the audience may change according to the time series.

In FIG. 5, the virtual position and the virtual direction of the player of the piano part corresponding to the user are set to position information Pp and direction information Pd. The virtual position and the virtual direction vary according to the movement of the HMD 60 (measured by the behavior sensor 64) described above. For example, when the user wearing the HMD 60 changes the direction of the head, the direction information Pd changes in accordance with the direction of the head. When the user wearing the HMD 60 moves, the position information Pp changes in accordance with the movement of the user. The position information Pp and the direction information Pd may be changed by an operation on the operation unit 14 or an input of an instruction from the user. Initial values of the position information Pp and the direction information Pd need only be set in advance in the music data 12b.

As will be described later, when a video is provided to the user via the HMD 60, the user can visually recognize other players arranged in the virtual space at the positions and directions (the position information Pp and the direction information Pd) shown in FIG. 5. For example, the player of the drum part (the position information C3p and the direction information C3d) is visually recognized by the user as an image of a player playing facing right at a front side on the left (the position indicated by a vector V3) with respect to the front direction.

### [Performance Following Function]

Next, a performance following function realized by the control unit 11 executing the program 12a will be described.

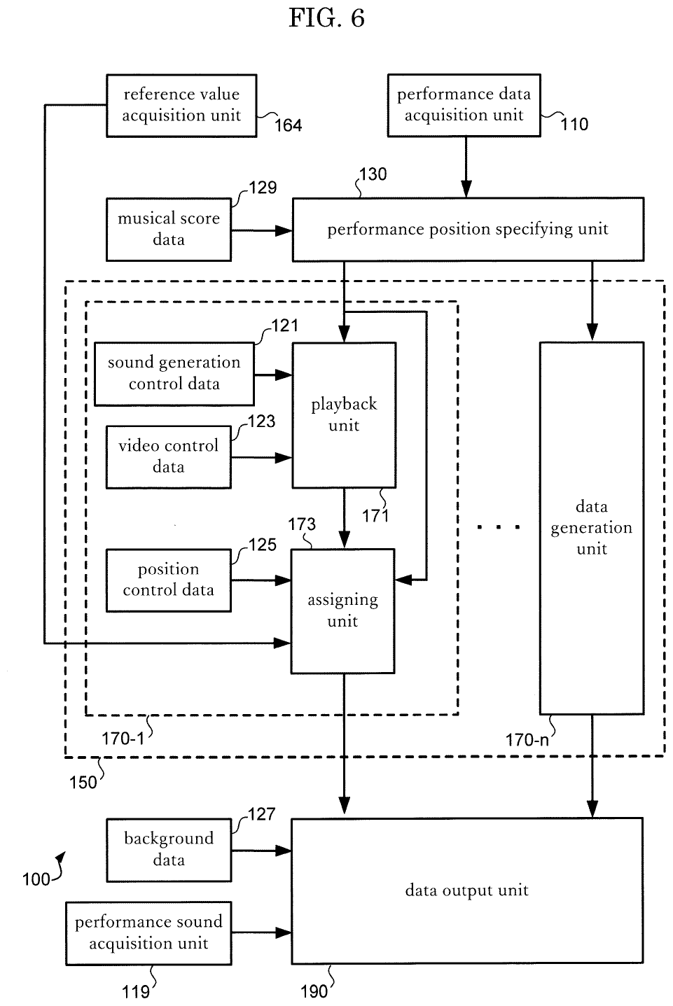

FIG. 6 is a diagram for explaining a configuration for realizing a performance following function in the first embodiment. A performance following function 100 includes a performance data acquisition unit 110, a performance sound acquisition unit 119, a performance position specifying unit 130, a signal processing unit 150, a reference value acquisition unit 164, and a data output unit 190. A configuration for realizing the performance following function 100 is not limited to the case where the configuration is realized by execution of a program, and at least a part of the configuration may be realized by hardware.

The performance data acquisition unit 110 acquires performance data. In this example, the performance data corresponds to the operation data provided from the electronic musical instrument 80. The performance sound acquisition unit 119 acquires sound data (performance sound data) corresponding to performance sounds provided from the electronic musical instrument 80. The reference value acquisition unit 164 acquires a reference value corresponding to a performance part of the user. The reference value includes a reference position and a reference direction. The reference position corresponds to the position information Pp described above. The reference direction corresponds to the direction information Pd. As described above, the control unit 11 changes the position information Pp and the direction information Pd from preset initialization values in accordance with movements of the HMD 60 (measured result by the behavior sensor 64). The reference value may be set in advance. At least one of the reference position and the reference direction among the reference values may be associated with time information, similar to the position control data 125. In this case, the reference value acquisition unit 164 may acquire the reference value associated with the time information on the basis of a corresponding relationship between a musical score performance position and time information described later.

The performance position specifying unit 130 refers to the musical score data 129 and specifies a musical score performance position corresponding to the performance data sequentially acquired by the performance data acquisition unit 110. The performance position specifying unit 130 compares a history of the sound generation control information in the performance data (that is, a set of the time information corresponding to a timing at which the operation data is acquired and the sound generation control information) with a set of the time information and the sound generation control information in the musical score data 129, and analyzes the corresponding relationship with each other by a predetermined matching process. Examples of the predetermined matching process include a known matching process using a statistical estimation model, such as DP matching, a hidden Markov model, or matching using machine learning. The musical score performance position may be specified at a preset speed for a predetermined time after the playing is started.

The performance position specifying unit 130 specifies a musical score performance position corresponding to the performance in the electronic musical instrument 80 from this corresponding relationship. The musical score performance position indicates a position currently played in the musical score in the musical score data 129, and is specified as time information in the musical score data 129, for example. The performance position specifying unit 130 sequentially acquires the performance data in association with the performance on the electronic musical instrument 80, and sequentially specifies the musical score performance positions corresponding to the acquired performance data. The performance position specifying unit 130 provides the specified musical score performance position to the signal processing unit 150.

The signal processing unit 150 includes data generation units 170-1, . . . , 170-n (referred to as data generation units 170 in the case where the respective units are not particularly distinguished). The data generation unit 170 is set corresponding to the setting data 120. As described above, in the case where the music data 12b includes four setting data 120 corresponding to three performance parts (vocal part, bass part, and drum part) and the audience, the signal processing unit 150 includes four data generation units 170 (170-1 to 170-4). As described above, the data generation unit 170 and the setting data 120 are associated with each other via the performance part.

The data generation unit 170 includes a playback unit 171 and an assigning unit 173. The playback unit 171 acquires the sound generation control data 121 and the video control data 123 from the associated setting data 120. The assigning unit 173 acquires the position control data 125 from the associated setting data 120.

The playback unit 171 reproduces the sound data and the video data based on the musical score performance position provided from the performance position specifying unit 130. The playback unit 171 refers to the sound generation control data 121, reads out the sound generation control information corresponding to the time information specified by the musical score performance position, and reproduces the sound data. The playback unit 171 can also be said to have a sound source unit that reproduces sound data based on the sound generation control data 121. The sound data is data corresponding to the performance sound of the associated performance part. In the case of the vocal part, the sound data may be data corresponding to singing sounds generated using at least text information and pitch information. The playback unit 171 refers to the video control data 123, reads out image control information corresponding to the time information specified by the musical score performance position, and reproduces the video data. The video data is data corresponding to an image of the player of the associated performance part, that is, a player image.

The assigning unit 173 assigns the position information and the direction information to the sound data and the video data reproduced by the playback unit 171. The assigning unit 173 refers to the position control data 125 and reads the position information and the direction information corresponding to the time information specified by the musical score performance position. The assigning unit 173 corrects the reference value acquired by the reference value acquisition unit 164, that is, read position information and direction information, using the position information Pp and the direction information Pd. Specifically, the assigning unit 173 converts the read position information and the direction information into relative information represented by a coordinate system with respect to the position information Pp and the direction information Pd. The assigning unit 173 assigns the corrected position information and the direction information, that is, the relative information, to the sound data and the video data.

In the example shown in FIG. 5, a virtual position and a virtual direction of the player of the piano part corresponding to the user are reference values. Therefore, among the relative information about the players and the audience of the respective performance parts, a part related to the position information includes information represented by vectors V1 to V4. Among the relative information, a part related to the direction information corresponds to a direction of direction information C1d, C2d, C3d, and C4d with respect to the direction information Pd (hereinafter referred to as a relative direction).

Assigning the relative information to the sound data corresponds to performing signal processing on the sound signals of a left channel (Lch) and a right channel (Rch) included in the sound data so that the sound image is localized at a predetermined position in the virtual space. The predetermined position is a position defined by the vector included in the relative information. In the exemplary embodiment shown in FIG. 5, for example, the performance sound of the drum part is localized at a position defined by the vector V3. At this time, a predetermined filtering process may be performed, for example, by using the HRTF (Head related transfer function) technique. The assigning unit 173 may perform signal processing so as to apply reverberant sound due to a structure of a room or the like to the sound signal with reference to the background data 127. In this case, the assigning unit 173 may impart directivity such that the sound is output from the sound image in the relative direction included in the relative information.

Assigning the relative information to the video data corresponds to performing image processing on the player image included in the video data so as to be arranged at a predetermined position in the virtual space and to be directed in a predetermined direction. The predetermined position is a position where the sound image described above is localized. The predetermined direction corresponds to the relative direction included in the relative information. In the embodiment shown in FIG. 5, for example, the player image of the drum part is visually recognized by the user wearing the HMD 60 so as to face the right side (more precisely, the right front side) at the position defined by the vector V3.

In this example, the data generation unit 170-1 outputs the video data and the sound data to which the position information is assigned with respect to the vocal part. The data generation unit 170-2 outputs the video data and the sound data to which the position information is assigned with respect to the bass part. The data generation unit 170-3 outputs the video data and the sound data to which the position information is assigned with respect to the drum part. The data generation unit 170-4 outputs the video data and the sound data to which the position information is assigned with respect to the audience.

The data output unit 190 synthesizes the video data and the sound data output from the data generation units 170-1, . . . , 170-n, and outputs the synthesized data as playback data. By supplying the playback data to the HMD 60, the user wearing the HMD 60 can visually recognize the player images of the vocal part, the bass part, and the drum part at positions corresponding to the respective positions, and can listen to the performance sounds corresponding to the respective positions. Therefore, improved realism is provided to the user. Further, in this example, the user can also visually recognize the audience, and can also listen to audience cheers or the like. In this case, since the video data and the sound data included in the playback data follow the performance of the user, the progress of the sound and the movement of the player image of each performance part change in accordance with the speed of the performance of the user. In other words, in a vicinity of a musical instrument played by the user, the performance, the singing, and the like following the performance are realized in a virtual environment. As a result, the user can acquire a sense that a plurality of people are performing even if the user is playing alone. Accordingly, an audience experience in which a high sense of realism is provided to a user is provided.

The data output unit 190 may refer to the background data 127 and include a background image imitating the venue in the virtual space in the video data. As a result, the user can visually recognize a situation in which the player images arranged in the positional relation as shown in FIG. 5 are playing on the stage ST. The data output unit 190 may output playback data further synthesized with the performance sound data acquired by the performance sound acquisition unit 119. As a result, the user can also listen to the performance sound through the HMD 60. The above is the description of the performance following function.

### [Method for Outputting Data]

Next, a method for outputting data executed by the performance following function 100 will be described. The data output method described herein begins when the program 12a is executed.

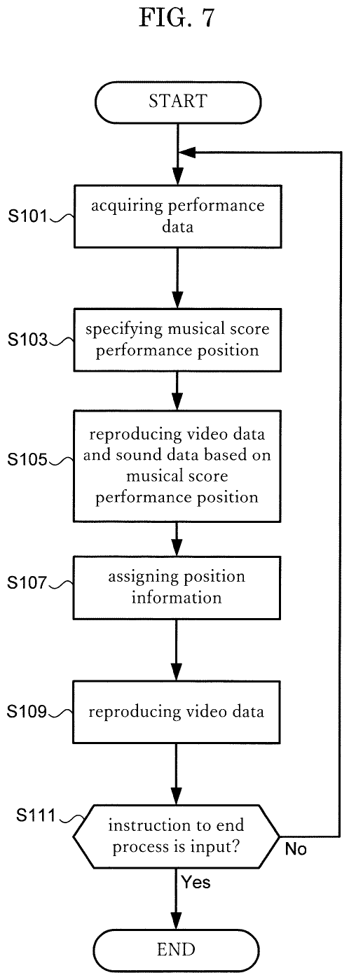

FIG. 7 is a diagram explaining a method for outputting data according to the first embodiment. The control unit 11 acquires performance data to be sequentially provided (step S101), and specifies a musical score performance position (step S103). The control unit 11 reproduces the video data and the sound data based on the musical score performance position (step S105), assigns the position information to the reproduced video data and the sound data (step S107), and outputs the reproduced video data and the sound data as the reproduced data (step S109). Until an instruction to end the process is input (step S111; No), the control unit 11 repeats the process from the step S101 to the step S109, and when an instruction to end the process is input (step S111; Yes), the control unit 11 ends the process.

### [Second Embodiment]

In the first embodiment, an example has been described in which the video data and the sound data are reproduced following the performance of one user, but the video data and the sound data may be reproduced following performances of a plurality of users. In the second embodiment, an example in which the video data and the sound data are reproduced following the performance of two users will be described.

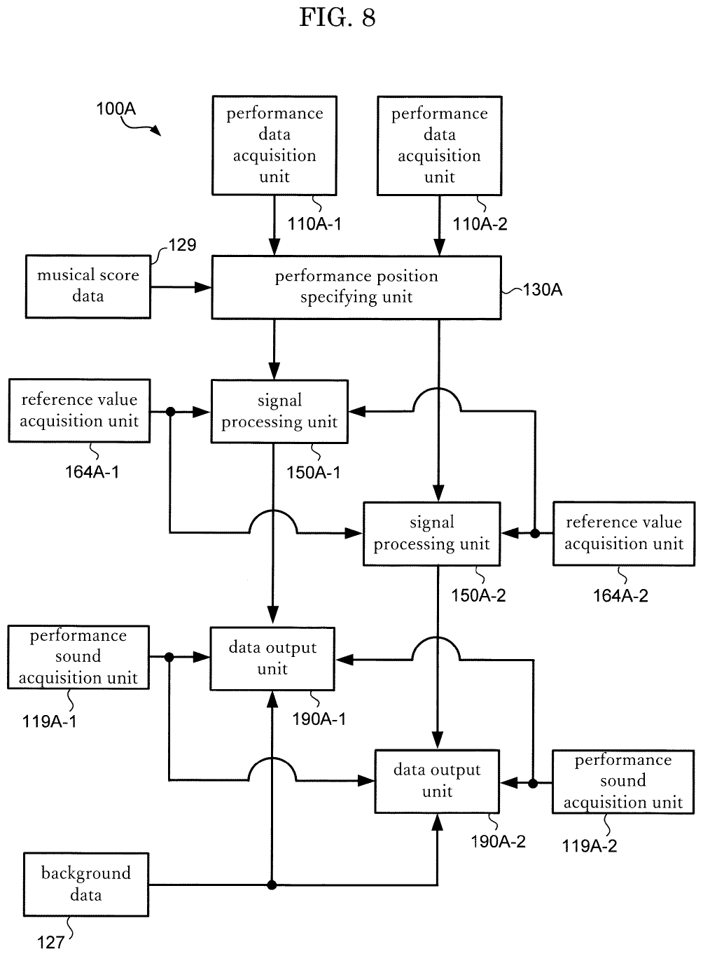

FIG. 8 is a diagram for explaining a configuration for realizing a performance following function in the second embodiment. A performance following function 100A according to the second embodiment has a configuration in which the two performance following functions 100 according to the first embodiment are in parallel, and the background data 127, the musical score data 129, and the performance position specifying unit 130 are shared by both users. Two performance following functions 100 are arranged corresponding to a first user and a second user.

A performance data acquisition unit 110A-1 acquires first performance data related to the first user. The first performance data is, for example, operation data output from the electronic musical instrument 80 played by the first user. A performance data acquisition unit 110A-2 acquires second performance data related to the second user. The second performance data is, for example, operation data output from the electronic musical instrument 80 played by the second user.

A performance position specifying unit 130A specifies a musical score performance position by comparing a history of sound generation control information in one of the first performance data and the second performance data with the sound generation control information in the musical score data 129. Which of the first performance data and the second performance data is to be selected is determined based on the first performance data and the second performance data. For example, the performance position specifying unit 130A executes both a matching process related to the first performance data and a matching process related to the second performance data, and adopts the musical score performance position specified by whichever has the higher calculation accuracy. For example, an index indicating a matching error in the calculation result may be used as the calculation accuracy.

As another example, the performance position specifying unit 130A determines whether to adopt the musical score performance position acquired from the first performance data or the musical score performance position acquired from the second performance data according to the position in the musical piece specified by the musical score performance position. In this case, in the score data 129, it is sufficient that a performance target period of the musical piece is divided into a plurality of periods, and a priority order is set for the performance part for each period. The performance position specifying unit 130A refers to the musical score data 129 and specifies a musical score performance position by using performance data corresponding to a performance part having a higher priority.

Signal processing units 150A-1 and 150A-2 have the same function as the signal processing unit 150 in the first embodiment, and respectively correspond to the first user and the second user. A signal processing unit 150A-1 reproduces the video data and the sound data using the musical score performance position specified by the performance position specifying unit 130A and a reference value relating to the first user acquired by a reference value acquisition unit 164A-1. In the signal processing unit 150A-1, the data generation unit 170 related to the performance part of the second user may or may not be present. The data generation unit 170 related to the performance part of the second user does not need to reproduce the sound data, and may reproduce the video data. In the reproduction of the video data, instead of using the position control data 125, a reference value related to the second user acquired by a reference value acquisition unit 164A-2 may be used.

The signal processing unit 150A-2 reproduces the video data and the sound data using the musical score performance position specified by the performance position specifying unit 130A and the reference value related to the second user acquired by the reference value acquisition unit 164A-2. In the signal processing unit 150A-2, the data generation unit 170 related to the performance part of the first user may or may not be present. The data generation unit 170 related to the performance part of the first user does not need to reproduce the sound data, and may reproduce the video data. In the reproduction of the video data, instead of using the position control data 125, the reference value related to the first user acquired by the reference value acquisition unit 164A-1 may be used.

A data output unit 190A-1 synthesizes the video data and the sound data output from the signal processing unit 150A-1, and outputs the synthesized data as playback data. This playback data is provided to the HMD 60 of the first user. The data output unit 190A-1 may refer to the background data 127 and include a background image that imitates the venue in the virtual space in the video data. The data output unit 190A-1 may output playback data further synthesized with the performance sound data acquired by performance sound acquisition units 119A-1 and 119A-2. The sound data acquired by the performance sound acquisition unit 119A-1 is, for example, sound data output from the electronic musical instrument 80 played by the first user. The sound data acquired by the performance sound acquisition unit 119A-2 is, for example, sound data output from the electronic musical instrument 80 played by the second user. Relative information corresponding to the reference value of the second user with respect to the reference value of the first user, or relative information assigned to the video data related to the performance part of the second user may be assigned to the sound data acquired by the performance sound acquisition unit 119A-2, and the sound image may be localized at a predetermined position.

The data output unit 190A-2 synthesizes the video data and the sound data output from the signal processing unit 150A-2, and outputs the synthesized data as playback data. This playback data is provided to the HMD 60 of the first user. The data outputting unit 190A-2 may refer to the background data 127 and include a background image that imitates the venue in the virtual space in the video data. The data output unit 190A-2 may output playback data further synthesized with the performance sound data acquired by the performance sound acquisition units 119A-1 and 119A-2. The relative information corresponding to the reference value of the first user with respect to the reference value of the second user, or the relative information assigned to the video data related to the performance part of the first user may be assigned to the sound data acquired by the performance sound acquisition unit 119A-1, and the sound image may be localized at a predetermined position.

As described above, according to the performance following function 100A of the second embodiment, it is possible to enhance the sense of realism given to the user even in the case where two performance parts are performed by the user.

### [Modification]

The present disclosure is not limited to the embodiments described above, and includes various other modifications. For example, the embodiments described above have been described in detail for the purpose of explaining the present disclosure in an easy-to-understand manner, and are not necessarily limited to those having all the described configurations. Some modifications will be described below. Although the modifications are described as modified examples of the first embodiment, the modifications can also be applied as modified examples of other embodiments. A plurality of modifications may be combined and applied to each embodiment.
(1) The video data and the sound data included in the playback data are not limited to being provided to the HMD 60, and may be provided to, for example, a stationary display. The video data and the sound data may be provided to different devices. For example, the video data may be provided to the HMD 60, and the sound data may be provided to a speaker device that differs from the HMD 60. The speaker device may be, for example, the speaker 87 in the electronic musical instrument 80. In the case where the sound data is provided to the speaker device, signal processing, assuming the speaker device, provided in the assigning unit 173 may be performed. For example, in the case of the speaker 87 of the electronic musical instrument 80, the speaker unit Lch and the speaker unit Rch are fixed to the electronic musical instrument 80, and the positions of the ears of the player are also roughly estimated. In such a case, the signal processing may be performed on the sound data so as to localize the sound image using a crosstalk cancellation technique from the two speaker units and the estimated positions of the right ear and the left ear of the player. In this case, signal processing may be performed on the sound data so as to acquire a shape of a room in which the electronic musical instrument 80 is installed and cancel a sound field according to the shape of the room. The shape of the room may be acquired by a known method such as a method using sound reflection or a method using imaging.
(2) At least one of the video data and the sound data included in the playback data does not need to be present. That is, at least one of the video data and the sound data may follow the performance of the user as the automatic processing.
(3) The assigning unit 173 does not need to assign the position information and the direction information to at least one of the video data and the sound data.
(4) Functions of the data output device 10 and functions of the electronic musical instrument 80 may be included in one device. For example, the data output device 10 may be incorporated as a function of the electronic musical instrument 80. A part of the configuration of the electronic musical instrument 80 may be included in the data output device 10, or a part of the configuration of the data output device 10 may be included in the electronic musical instrument 80. For example, a configuration other than the performance operator 84 of the electronic musical instrument 80 may be included in the data output device 10. In this case, the data output device 10 may generate the sound data from the acquired operation data using the sound source unit.
(5) The musical score data 129 may be included in the music data 12b in the same format as the setting data 120. In this case, by setting the performance part of the user to the data output device 10, the sound generation control data 121 included in the setting data 120 corresponding to the performance part may be used as the musical score data 129.
(6) Although the position information and the direction information are specified as a virtual position and a virtual direction in the virtual space, the position information and the direction information may be specified as a virtual position and a virtual direction in a virtual plane, and it is sufficient that the position information and the direction information are specified as information defined in a virtual region.
(7) The position control data 125 in the setting data 120 does not need to include the direction information, and does not need to include the time information.
(8) The assigning unit 173 may not change the position information to be assigned to the sound data based on the position control data 125. For example, the position information may be fixed at the initial value. In this way, the player image can be moved while assuming a situation in which the sound is generated from a specific speaker (a situation in which the sound image is fixed). As a result, the sound image may be localized at a position different from the position of the player image. The information included in the position control data 125 may be arranged separately for the video data and the sound data, so that the player image and the sound image can be controlled at different positions.
(9) The video data included in the playback data may be still image data.
(10) The performance data acquired by the performance data acquisition unit 110 may be sound data (performance sound data) instead of the operation data. In the case where the performance data is sound data, the performance position specifying unit 130 compares the sound data which is the performance data with sound data generated based on the musical score data 129 and performs a known matching process. Through this processing, the performance position specifying unit 130 may specify musical score performance positions corresponding to performance data sequentially acquired. The musical score data 129 may be sound data. In this case, time information is associated with each part of the sound data.
(11) The sound generation control data 121 included in the music data 12b may be sound data. In this case, time information is associated with each part of the sound data. In the case of vocal part sound data, the sound data includes singing sound. When the playback unit 171 reads out this sound data based on the musical score performance position, the playback unit 171 may read out the sound data based on a relationship between the musical score performance position and the time information, and adjust a pitch according to a reading speed. The adjustment of the pitch may be performed so as to become a pitch when the sound data is read at a predetermined reading speed, for example.
(12) The control unit 11 may record the playback data output from the data output unit 190 on a recording medium or the like. The control unit 11 may generate data for recording for outputting playback data and may record the data on a recording medium. The recording medium may be the storage unit 12 or may be a computer-readable recording medium connected as an external device. The data for recording may be transmitted to a server device connected via the network NW. For example, the data for recording may be transmitted to the data management server 90 and stored in the storage unit 92. The data for recording may be in a form including video data and sound data, or may be in a form including the setting data 120 and time-series information of the musical score performance position. In the latter case, playback data may be generated from the recording data by a function corresponding to the signal processing unit 150 and the data output unit 190.
(13) The performance position specifying unit 130 may specify the musical score performance position regardless of the performance data acquired by the performance data acquisition unit 110 in a partial period of the musical piece. In this case, the musical score data 129 may define a progress speed of the musical score performance position to be specified in a part of the period of the musical piece. In this period, the performance position specifying unit 130 may specify that the musical score performance position is changed at a specified progress speed.
(14) Among the setting data 120 included in the music data 12b, the setting data 120 usable in the performance following function 100 may be limited by the user. In this case, the data output device 10 may realize the performance following function 100 on the premise that a user ID is input. The restricted setting data 120 may be changed by the user ID. For example, in the case where the user ID is a particular ID, the control unit 11 may perform control so that the setting data 120 relating to the vocal part cannot be used in the performance following function 100. A relationship between the ID and the restricted data may be registered in the data management server 90. In this case, the data management server 90 may prevent the setting data 120 that cannot be used from being included in the music data 12b when providing the music data 12b to the data output device 10.

The above is the description of the modification.

As described above, according to an embodiment of the present disclosure, there is provided a method for outputting data including acquiring performance data generated by a performance operation, specifying a musical score performance position in a predetermined musical score based on the performance data, reproducing first data based on the musical score performance position, assigning first position information, corresponding to a first virtual position set corresponding to the first data, to the first data, and outputting playback data including the first data to which the first position information is assigned.

The first virtual position may be further set corresponding to the musical score performance position.

The first data may include sound data.

The sound data may include singing sounds.

The singing sound may be generated based on text information and pitch information.

The assigning the first position information to the first data may include performing signal processing for localizing a sound image in the sound data.

The first data may include video data.

The first position information corresponding to the first virtual position may include relative information of the first virtual position with respect to a reference position and a reference direction to be set.

The method may include changing at least one of the reference position and the reference direction based on an instruction input from a user.

At least one of the reference position and the reference direction may be set corresponding to the musical score performance position.

The method may include assigning, to the first data, first direction information corresponding to a first virtual direction set corresponding to the first data.

The method may include reproducing second data based on the musical score performance position, and assigning second position information corresponding to a second virtual position set corresponding to the second data to the second data. The playback data may include the second data to which the second position information is assigned.

The playback data may include performance sound data corresponding to the performance operation.

The method may include generating recording data for outputting the playback data.

The method may include selecting either one of the first performance data and the second performance data based on the first performance data and the second performance data. The acquiring the performance data may include acquiring at least the first performance data generated by a performance operation of a first performance part and the second performance data generated by a performance operation of a second performance part. The musical score performance position may be specified based on the selected first performance data or the selected second performance data.

The performance data may include performance sound data corresponding to the performance operation.

The performance data may include operation data corresponding to the performance operation.

A program for causing a processor to execute the method for outputting data described in any of the above may be provided.

A data output device including a memory storing the program described above and a processor (control unit) for executing the program may be provided.

The device may include a sound source unit that generates sound data according to the performance operation.

An electronic musical instrument including the data output device described above and a performance operator for inputting the performance operation may be provided.

According to the present disclosure, it is possible to enhance a sense of realism given to a user in automatic processing following a performance of the user.

What is claimed is:

1. A method for outputting data comprising:
acquiring performance data generated by a performance operation;
specifying a musical score performance position in a predetermined musical score based on the performance data;
reproducing first data based on the musical score performance position;
assigning first position information, corresponding to a first virtual position set corresponding to the first data, to the first data; and
outputting playback data including the first data to which the first position information is assigned.

2. The method for outputting data according to claim 1, wherein
the first virtual position is further set corresponding to the musical score performance position.

3. The method for outputting data according to claim 1, wherein
the first data includes sound data.

4. The method for outputting data according to claim 3, wherein
the sound data includes singing sounds.

5. The method for outputting data according to claim 4, wherein
the singing sounds are generated based on text information and pitch information.

6. The method for outputting data according to claim 3, wherein
the assigning the first position information to the first data includes performing signal processing for localizing a sound image in the sound data.

7. The method for outputting data according to claim 1, wherein
the first data includes video data.

8. The method for outputting data according to claim 1, wherein
the first position information corresponding to the first virtual position includes relative information of the first virtual position with respect to a reference position and a reference direction to be set.

9. The method for outputting data according to claim 8, further comprising changing at least one of the reference position and the reference direction based on an instruction input from a user.

10. The method for outputting data according to claim 8, wherein
at least one of the reference position and the reference direction is set corresponding to the musical score performance position.

11. The method for outputting data according to claim 1, further comprising assigning, to the first data, first direction information corresponding to a first virtual direction set corresponding to the first data.

12. The method for outputting data according to claim 1, further comprising:
reproducing second data based on the musical score performance position; and
assigning second position information corresponding to a second virtual position set corresponding to the second data to the second data,
wherein the playback data includes the second data to which the second position information is assigned.

13. The method for outputting data according to claim 1, wherein
the playback data includes performance sound data corresponding to the performance operation.

14. The method for outputting data according to claim 1, further comprising generating recording data for outputting the playback data.

15. The method for outputting data according to claim 1, further comprising selecting either one of the first performance data and the second performance data based on the first performance data and the second performance data, wherein
the acquiring the performance data includes acquiring at least the first performance data generated by a performance operation of a first performance part and the second performance data generated by a performance operation of a second performance part, and
the musical score performance position is specified based on the selected first performance data or the selected second performance data.

16. The method for outputting data according to claim 1, wherein
the performance data includes operation data corresponding to the performance operation.

17. A data output device comprising:
a memory storing the program;
a control unit configured to execute the program; and
a sound source unit configured to generate sound data according to a performance operation, wherein
the control unit is configured to, when the program is executed,
acquire performance data generated by the performance operation,
specify a musical score performance position in a predetermined musical score based on the performance data,
reproduce first data based on the musical score performance position,
assign first position information corresponding to a first virtual position set corresponding to the first data to the first data, and
output playback data including the first data to which the first position information is assigned.

18. The data output device according to claim 17, wherein
the first virtual position is further set corresponding to the musical score performance position.

19. The data output device according to claim 17, wherein
the first data includes sound data.

20. An electronic musical instrument comprising:
the data output device according to claim 17, and
a performance operator for inputting the performance operation.
